(19) United States
(12) Patent Application Publication
(10) Pub. No.: US 2015/0097567 A1
(43) Pub. Date: Apr. 9, 2015

(54) Dual-radiation non-ferrous metal prospecting system

(71) Applicants: Carl E. Berg, Cupertino, CA (US); Thomas Roger Haas, Santa Cruz, CA (US); Douglas Gene Lockie, Los Gatos, CA (US)

(72) Inventors: Carl E. Berg, Cupertino, CA (US); Thomas Roger Haas, Santa Cruz, CA (US); Douglas Gene Lockie, Los Gatos, CA (US)

(21) Appl. No.: 13/998,177

(22) Filed: Oct. 7, 2013

(51) Int. Cl. G01V 3/12

(52) U.S. Cl. CPC G01V 3/12
USPC 324/326

(57) ABSTRACT

Methods and apparatus for a Dual Emission Non-Ferrous Metal Prospecting System are disclosed. One embodiment comprises methods and apparatus for finding metal deposits in the Earth, and then determining whether these metal deposits are ferrous or non-ferrous. One embodiment includes an Electromagnetic Quartz Penetrator. The Electromagnetic Quartz Penetrator includes a transmitter, a receiver, antennas and a first signal processor. One embodiment also includes an Omni-Directional H Field Metal Exciter and Sensor. The Omni-Directional H field exciter produces an output which has a spatial dissipation rate proportional to a factor of 1/r³, and, therefore, has a relatively short range compared to the Electromagnetic Plane.

### FIELD OF THE INVENTION

The present invention relates to mining. More particularly, embodiments of the present invention provide methods and apparatus for locating and then detecting non-ferrous metal behind the wall of an underground mine.

### CROSS-REFERENCE TO RELATED PATENT APPLICATIONS & CLAIMS FOR PRIORITY

None.

### FEDERALLY SPONSORED RESEARCH OR DEVELOPMENT

None.

### BACKGROUND OF THE INVENTION

According to the website Goldsheetlinks, the annual world-wide production of gold exceeded 2,500 metric tons in 2010. Over the past year, the price of one ounce of gold has fallen from $1,800 to around $1,300. Meanwhile, the cost of producing an ounce of gold has been increasing for many mining operations. In June of 2013, when the price of gold dropped under $1,200 per ounce, the price exceeded the cost of production for some miners. The average cost of producing gold in Australia has nearly doubled over the past six years, rising from $500 to over $1,000 per ounce from 2007 to 2013.

The gold mining industry desperately requires a new system for producing gold at a lower cost. The development of a method and apparatus for producing gold at a reduced cost would constitute a major technological advance, and would satisfy long-felt needs in the gold and other precious metal extraction businesses.

### SUMMARY OF THE INVENTION

The present invention comprises methods and apparatus for finding metal deposits in the Earth, and then determining whether these metal deposits are ferrous or non-ferrous.

One embodiment of the invention includes an Electromagnetic Quartz Penetrator. The Electromagnetic Quartz Penetrator includes a transmitter, a receiver, antennas and a first signal processor.

The Electromagnetic Quartz Penetrator is a portable device which is installed inside a mine, and is then aimed at an interior wall of the mine. The Electromagnetic Quartz Penetrator transmitter generates an Electromagnetic Plane Wave, which produces both an electric field and a first magnetic field. The electric field and the first magnetic field are mutually orthogonal. The Electromagnetic Plane Wave is directed at the interior wall of a mine by an antenna or by an antenna array. The area of the wall which is irradiated by Electromagnetic Plane Wave is generally a few feet wide and a few feet high.

The Electromagnetic Plane Wave travels deep into the Earth. In this embodiment, the Electromagnetic Plane Wave is useful to a depth ranging from zero to forty feet measured from the surface of the wall. The power of the Electromagnetic Plane Wave dissipates at a rate proportional to 1/r².

The Electromagnetic Plane Wave penetrates a small three-dimensional volume of Earth which is adjacent to and lies immediately behind the area of the wall that is irradiated by the Electromagnetic Plane Wave.

The Electromagnetic Plane Wave finds deposits of metal within this volume of Earth behind the surface of the wall. The location of the metal deposits is determined by receiving waves which are reflected from the metal deposits, and by using the signal processor to interpret the received reflected waves. A graphical output is generated on a display that is read by the operator of the Quartz Penetrator. This graphical output provides the x, y and z coordinates of the metal deposit in a vein of quartz.

The present invention also includes an Omni-Directional H Field Metal Exciter and Sensor. The Omni-Directional H field exciter produces an output which has a spatial dissipation rate proportional to a factor of 1/r³, and, therefore, has a relatively short range compared to the Electromagnetic Plane Wave.

After the Electromagnetic Quartz Penetrator is used to determine the spatial coordinates of metal deposits behind the irradiated wall, a number of holes is drilled in the wall toward the location of the metal deposits. The Exciter is placed in a first hole, and then is activated. The Sensor is placed in a second hole. The Exciter produces a second magnetic field, which induces an eddy current in a metal deposit that has been found by the Electromagnetic Quartz Penetrator. The eddy current resembles a generally circular swirl of current around the metal deposit, and generates a return magnetic field. The Sensor detects the return magnetic field created by the eddy currents induced by the Exciter. A second signal processor, which is connected to the Sensor, interprets the signal collected by the Sensor.

If the induced eddy current in a metal deposit creates a return magnetic field in a very short interval of time, the metal deposit is known to be non-ferrous, and, therefore, probably contains gold.

If the induced eddy current in a metal deposit creates a return magnetic field over a relatively longer period of time, the metal deposit is know to be ferrous, and, therefore, does not contain gold. This method is also effective for identifying platinum and other precious non-ferrous metals.

The method and apparatus described in this embodiment of the invention may be used to accurately and reliably predict the location of gold in a quartz mine. This method and apparatus produces new and surprising successful results, and succeeds where previous mining methods have failed. The present invention lowers the cost of producing gold, and offers a great advantage to the gold mining industry.

An appreciation of the other aims and objectives of the present invention, and a more complete and comprehensive understanding of this invention, may be obtained by studying the following description of a preferred embodiment, and by referring to the accompanying drawings.

### A BRIEF DESCRIPTION OF THE DRAWINGS

FIG. 1 is a schematic diagram showing the inside of an underground gold mine. An Electromagnetic Quartz Penetrator has been installed in the mine, and is used to irradiate a portion of a vertical wall inside the mine. The volume of Earth shown behind the wall contains a quartz vein. The Electromagnetic Quartz Penetrator emits an Electromagnetic Plane Wave toward the vertical wall, and irradiates the volume of Earth behind it to a depth of about forty feet. A metal deposit contained in this volume of Earth is identified, its location coordinates are determined, and then are graphically depicted on a display.

FIG. 2 is a schematic illustration of the Electromagnetic Plane Wave created by the Electromagnetic Quartz Penetrator.

FIG. 3 is an illustration of the transmit signal generated by the Electromagnetic Plane Wave, and of the real and complex portions of the signal reflected from a metal deposit.

FIG. 4 shows the same volume of Earth behind the vertical wall shown in FIG. 1. Using the location coordinates of the detected metal deposit, one or more holes are drilled into the vertical wall around the deposit of metal. These holes are generally orthogonal to the vertical wall of the mine.

FIG. 5 reveals the propagation characteristics of the H Field created by the H Field exciter.

FIG. 6 shows an H Field Exciter being inserted into one of the holes drilled around the area of the metal deposit.

FIG. 7 shows the Exciter being pushed deeper into a hole.

FIG. 8 shows the H Field emission, and the return H Field that originates from the metal deposit.

FIG. 9 shows an induced eddy current which is created by the H Field emission that bombards the metal deposit.

FIG. 10 reveals how the H Field Exciter and cable are sheathed in PVC pipe.

FIGS. 11, 12, 13, 14 and 15 show how the cable and pipe are inserted into the wall in the mine wall.

FIG. 16 supplies a view of an alternative embodiment, which includes a number of exciters and sensors placed in a number of holes.

FIG. 17 is a schematic block diagram of the circuitry of one embodiment of the invention.

FIG. 18 is a schematic diagram of the circuitry of one embodiment of the invention.

FIG. 19 shows successful experimental results achieved by the invention.

### A DETAILED DESCRIPTION OF PREFERRED & ALTERNATIVE EMBODIMENTS

### I. Preferred & Alternative Embodiments

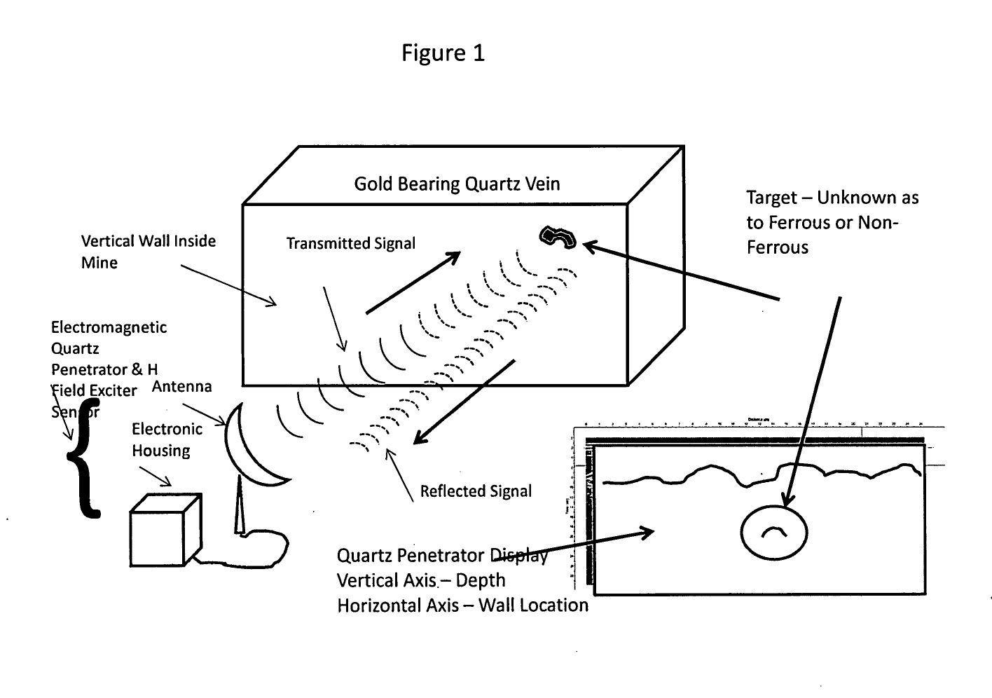

FIG. 1 is a schematic diagram that shows how the present invention is used in an underground mine. The objective of the invention is to find and to identify non-ferrous metals, and, specifically, to obtain gold.

In this Specification, and in the Claims that follow, the term “mine” refers to any portion of the Earth, the Moon, or any other Celestial Body, whether exposed to the atmosphere, under a body of water, in space or underground, which is used to extract a mineral, an ore, an aggregate, a mixture or some other material or substance.

The term “metal” is a generally solid material at or near room temperature. Metals typically have high electrical conductivity, luster and malleability. Metals have electrons that are readily lost in chemical reactions with other substances. The Periodic Table currently includes 118 elements—91 of these are classified as metals.

The term “non-ferrous” refers to any metal or alloy that does not contain iron in appreciable amounts.

One embodiment of the invention utilizes an Electromagnetic Quartz Penetrator and an H-Field Exciter & Sensor. Both the Electromagnetic Quartz Penetrator and the H-Field Exciter & Sensor are contained in a control box. The control box is connected to a power supply (not shown) and transmit and receive antennas.

FIG. 1 depicts the Electromagnetic Quartz Penetrator in a mine tunnel, and positioned near a section of the wall of the tunnel. This section of the wall is generally vertical, meaning that it extends roughly perpendicular to the floor of the mine at this point. This mine is generally known to contain veins of quartz.

The transmit antenna of the Electromagnetic Quartz Penetrator irradiates a portion of a vertical wall inside the mine. The volume of Earth shown behind the wall contains a quartz vein. In one embodiment of the invention, the Electromagnetic Quartz Penetrator emits an Electromagnetic Plane Wave toward the vertical wall, and irradiates the volume of Earth behind it to a depth of about forty feet. When a deposit of metal is encountered, the metal reflects a signal back to receiving antenna. A signal processor connected to the receiving antenna interprets this reflected signal, and identifies the deposit as bearing metal. The signal processor also determines the location coordinates within the irradiated volume of Earth, and then are graphically depicted on a display. These coordinates may be displayed as Cartesian coordinates x, y and z; or as Polar coordinates r, Θ; or as any other suitable mathematical means of providing the spatial location of the metal deposit.

FIG. 1 also depicts a screen shot of a graphical display that shows a curve and an artifact that indicate the location of the metal deposit.

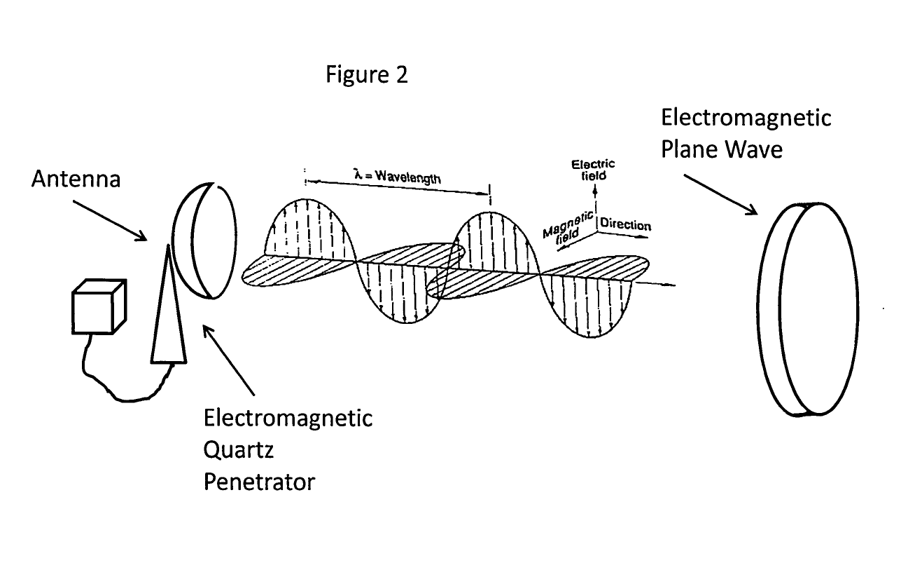

FIG. 2 is a generalized illustration of the characteristics of the Electromagnetic Plane Wave created by the Electromagnetic Quartz Penetrator. An electric field, also known as an E field, is shown propagating along the plane defined by the x and y axes. A magnetic field, also known as an H field, is shown propagating along the x and z axes. These two fields are mutually orthogonal, and, together, propagating along the x and z axes. These two waves are mutually orthogonal, and, together, comprise the Electromagnetic Plane Wave which is used to find metal behind the wall of the mine.

The Electromagnetic Plane Wave is designed to travel deep into the Earth behind the vertical wall. The power of the Electromagnetic Plane Wave falls by a factor of 1/r². In recent experiments which are described in Section II of this Specification, the Electromagnetic Plane Wave is useful up to depths of about forty feet.

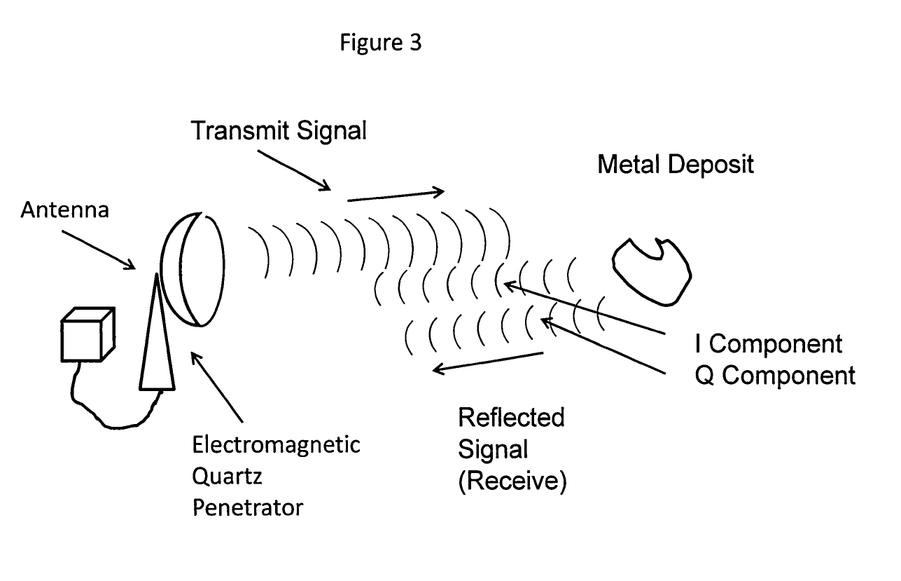

FIG. 3 depicts a waveforms which include the real and imaginary components of the energy reflected from the metal deposit. According to well known mathematics of phasor analysis, and equation may comprise both a real and an imaginary component:

a+bi=c where i²=−1 Equation One.

k=r(cos θ)+i(sin θ) Equation Two.

In one embodiment of the invention, both the energy reflected from the deposit of metal may be resolved into real and imaginary components, and these two components may be used to verify the deposit as bearing metal. The real and imaginary components may also be used to determine the location of the metal deposit in the irradiated area.

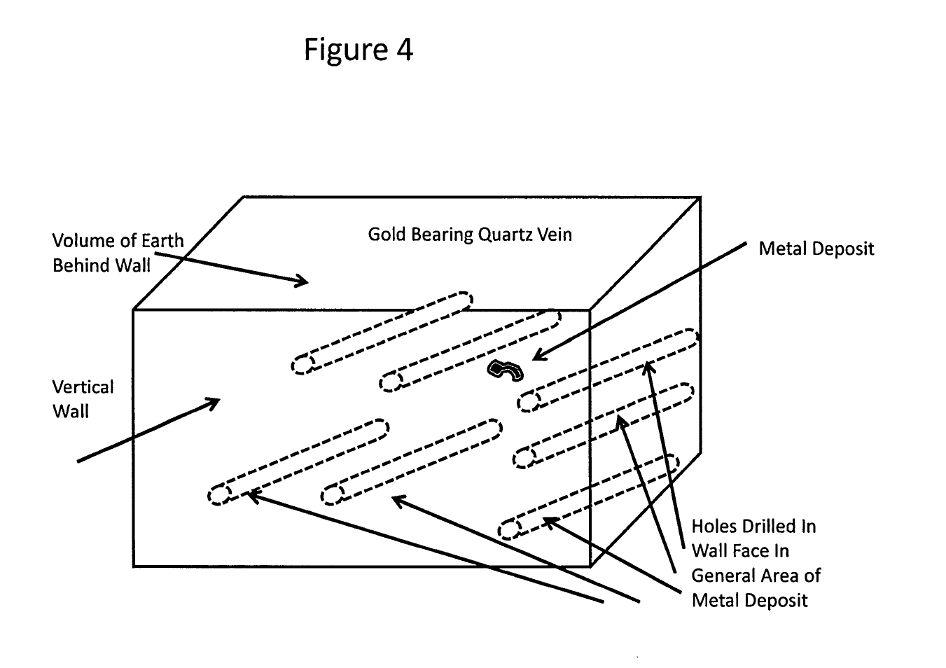

FIG. 4 is another view of the volume of Earth that has been irradiated, and is now known to contain a deposit of metal. At this point in time, it is not known whether the metal is ferrous or non-ferrous. Gold is only contained in non-ferrous deposits.

After the Electromagnetic Plane Wave has been used to locate a deposit of metal, one or more holes are drilled in the wall, as shown in FIG. 4. These holes are generally formed so that they are perpendicular to the vertical wall of the mine. The holes are generally drilled so that they surround the location of the metal deposit. These holes are formed using drilling equipment which is well known to those ordinarily skilled in the art of mining.

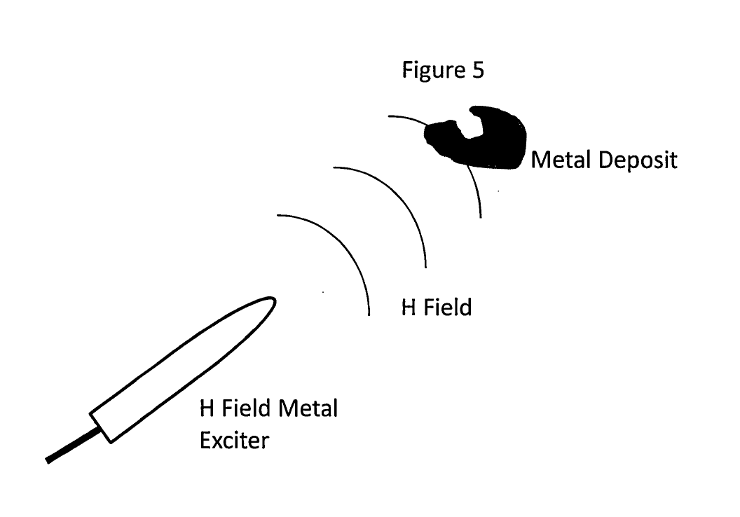

FIG. 5 reveals the propagation characteristics of the H Field created by an H Field exciter. The power of the H Field falls by a factor of VP as it travels into the Earth. For this reason, the H Field has a much shorter useful range when compared to the Electromagnetic Plane Wave, which falls by a factor of 1/r². The combination of the 1/r² and 1/r³ emanations enable the present invention to both locate and to identify precious non-ferrous metals in a mine.

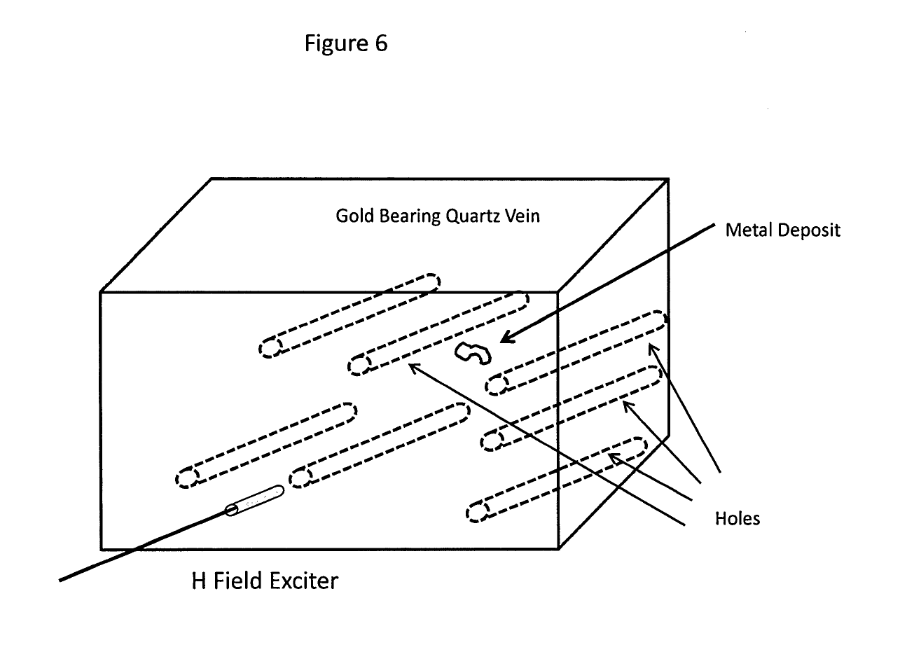

FIG. 6 shows the H Field Exciter and its connecting cable being inserted into one of the holes drilled around the area of the metal deposit.

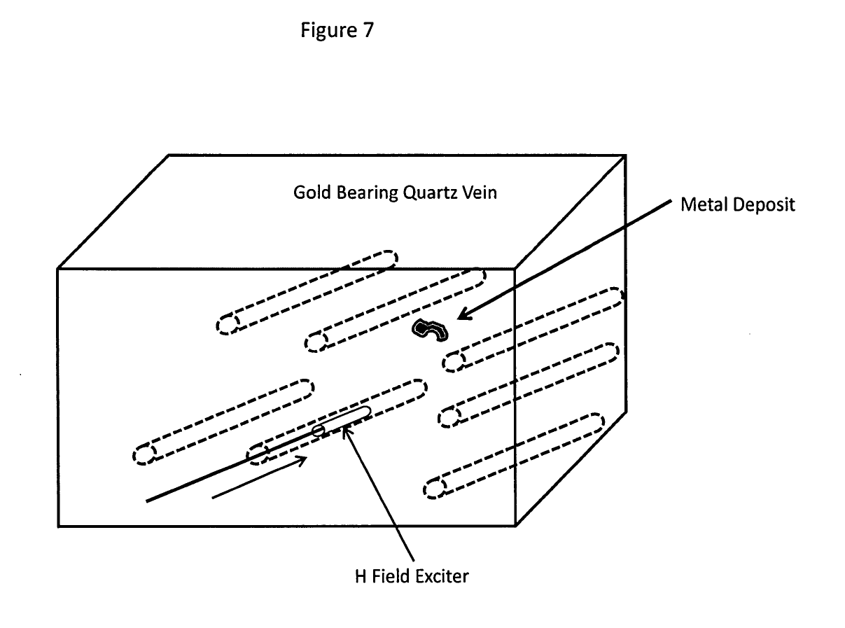

FIG. 7 shows the Exciter and the cable being pushed deeper into a hole.

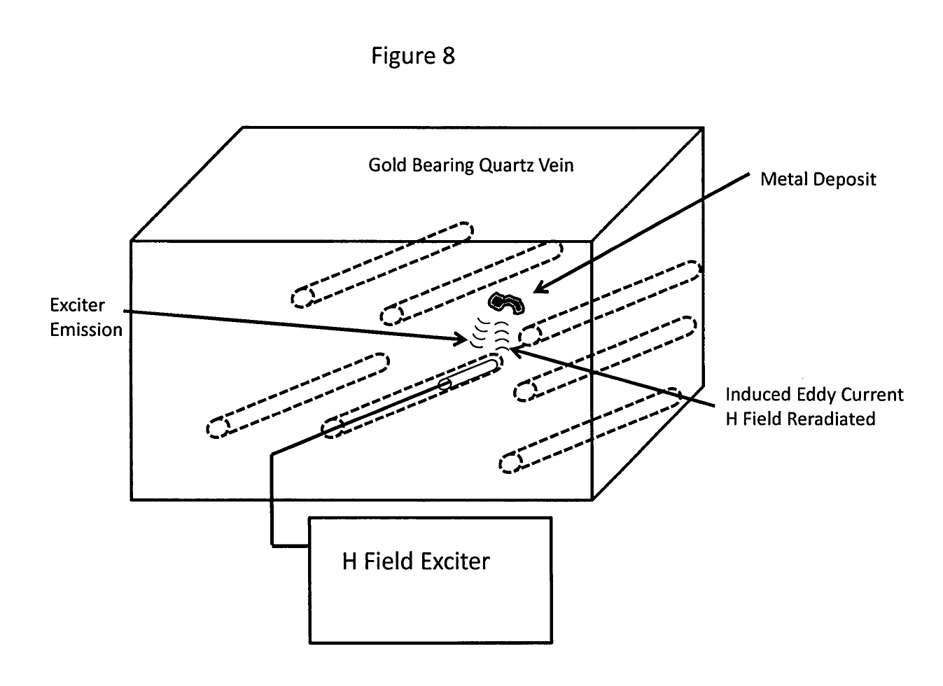

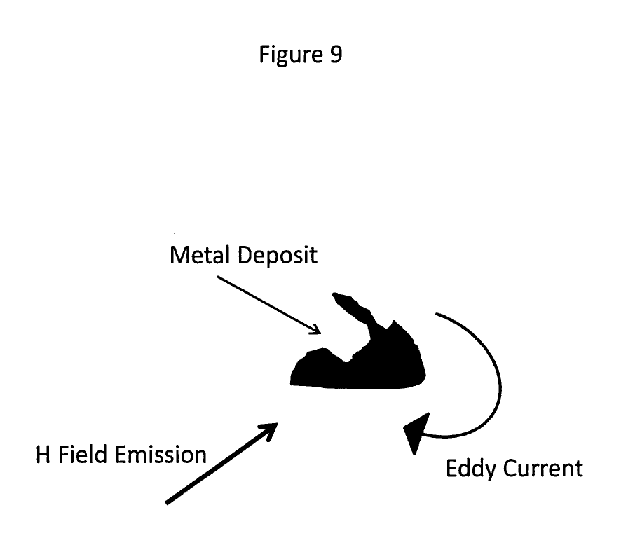

FIG. 8 shows an H Field emission, and a return H Field that originates from the metal deposit. The H Field emission induces an eddy current in the metal deposit, which is shown as a clock-wise swirl of current in FIG. 9.

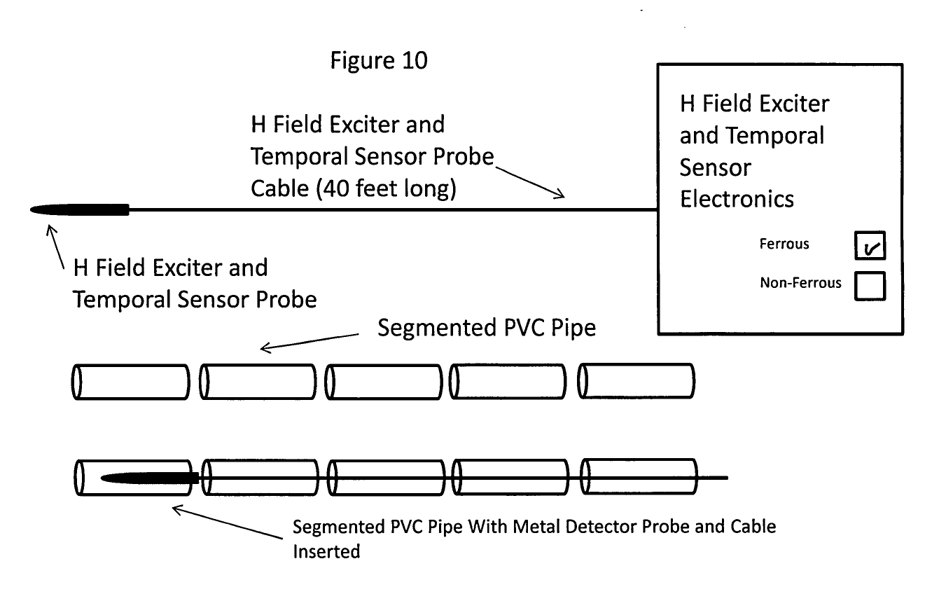

FIG. 10 reveals how the H Field Exciter and cable are sheathed in several pieces of segmented PVC pipe.

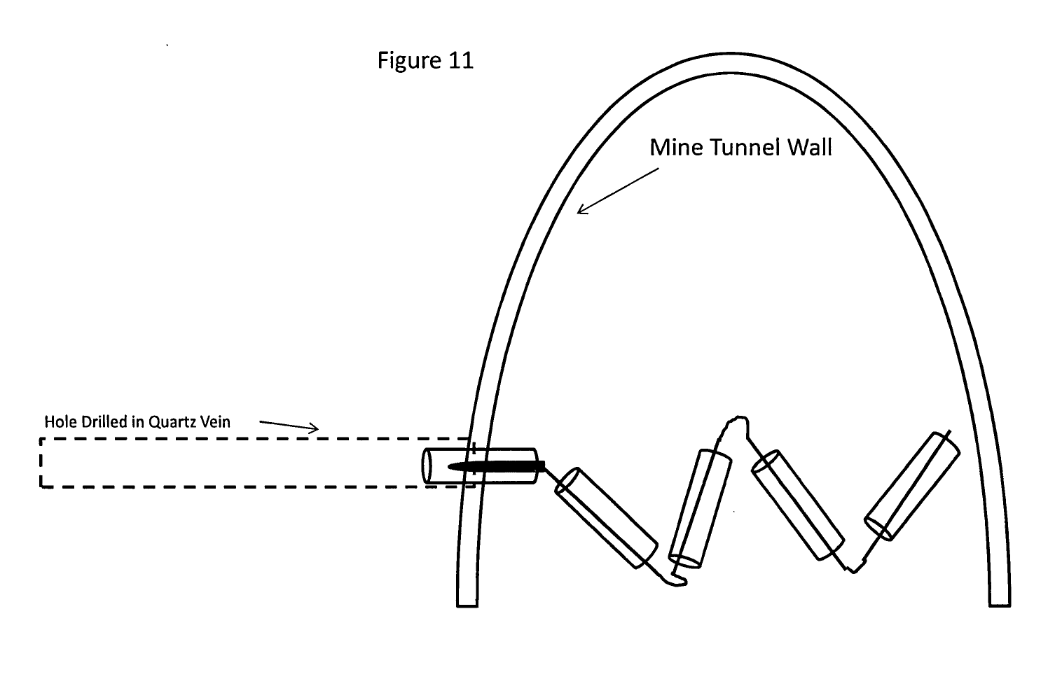

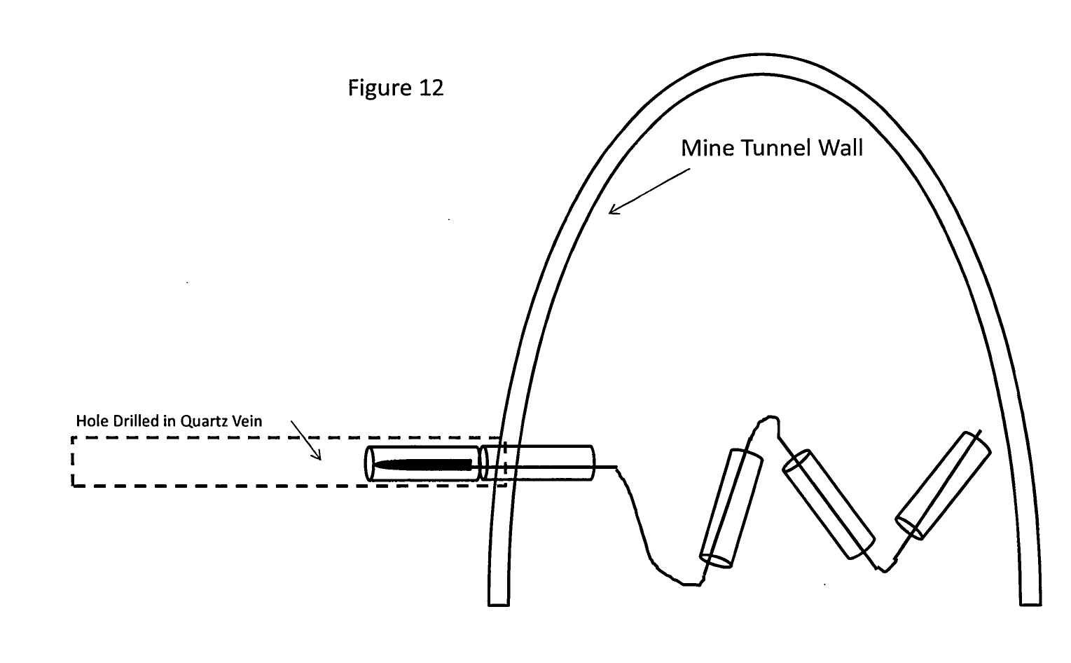

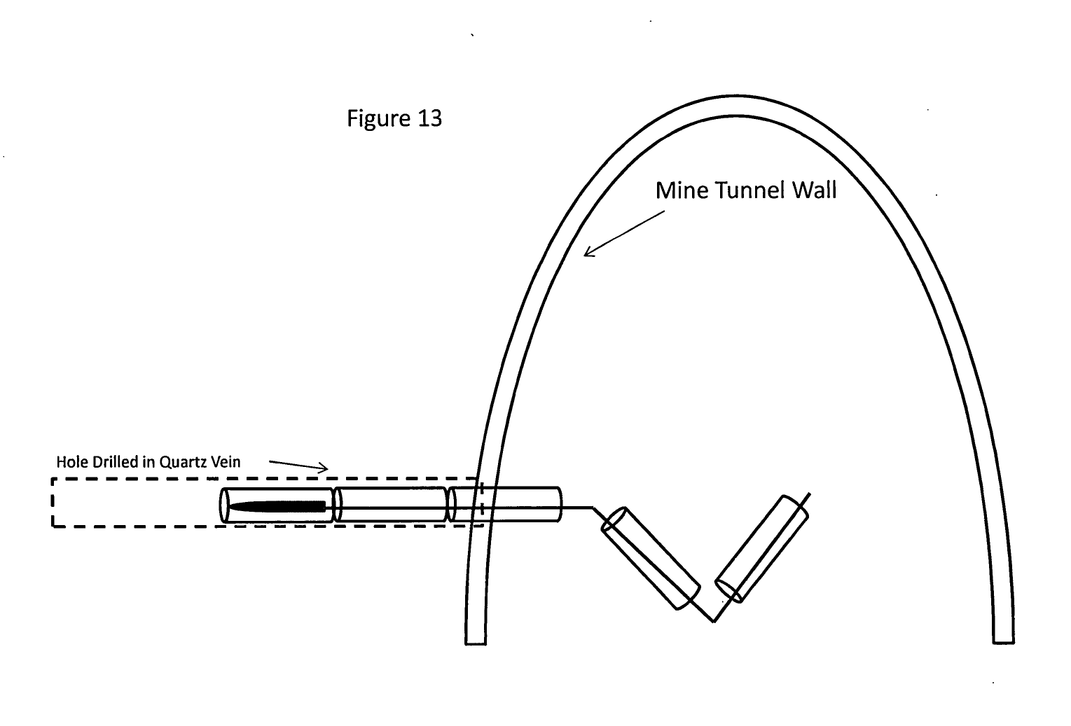

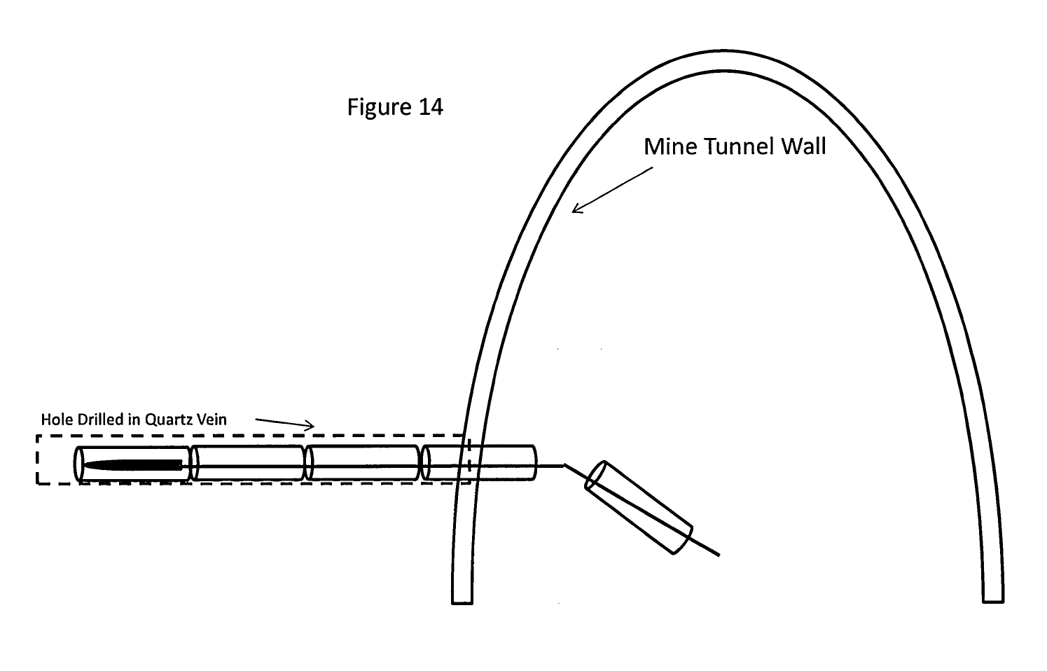

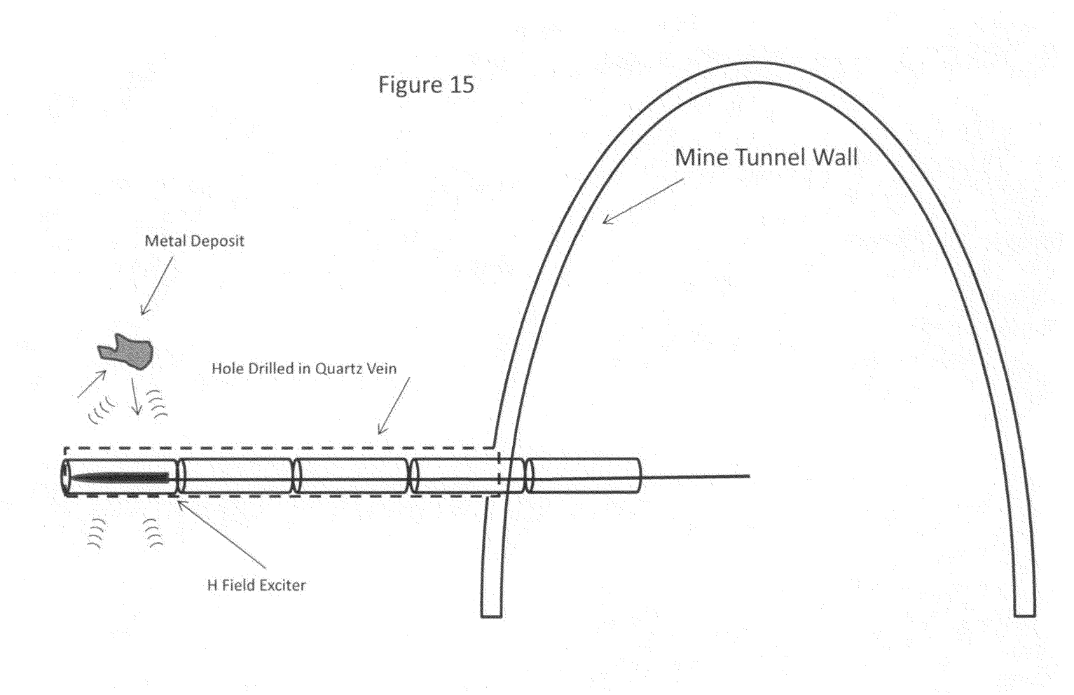

FIGS. 11, 12, 13, 14 and 15 show how the cable and pipe are inserted into a hole that has been drilled in the mine wall.

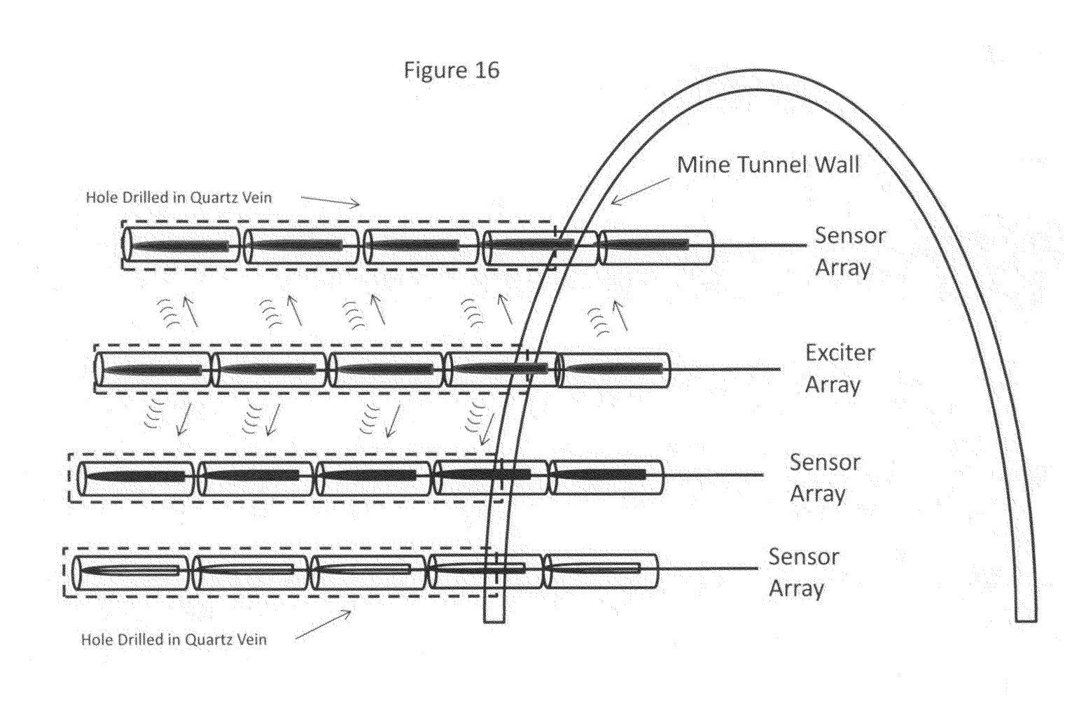

FIG. 16 supplies a view of an alternative embodiment, which includes a number of exciters and sensors placed in a number of holes.

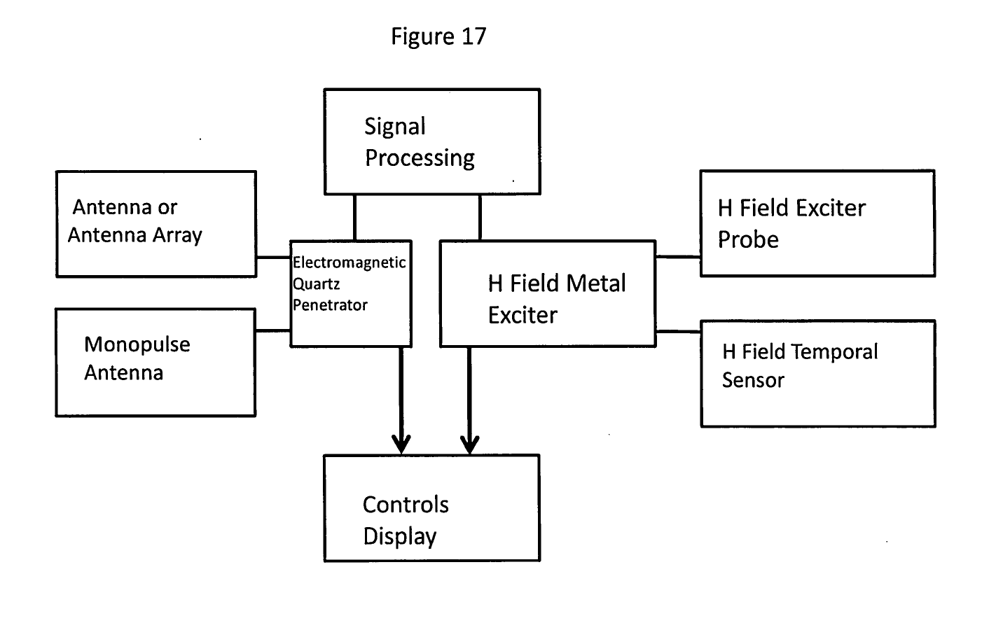

FIG. 17 is a schematic block diagram of the circuitry of one embodiment of the invention. The Electromagnetic Quartz Penetrator is connected to an antenna, or to an antenna array; as well as to a monopulse antenna. The H Field Metal Exciter is connected to a probe and to a transducer or sensor. Both the Electromagnetic Quartz Penetrator and the H Field Metal Exciter are connected to controls and to a display.

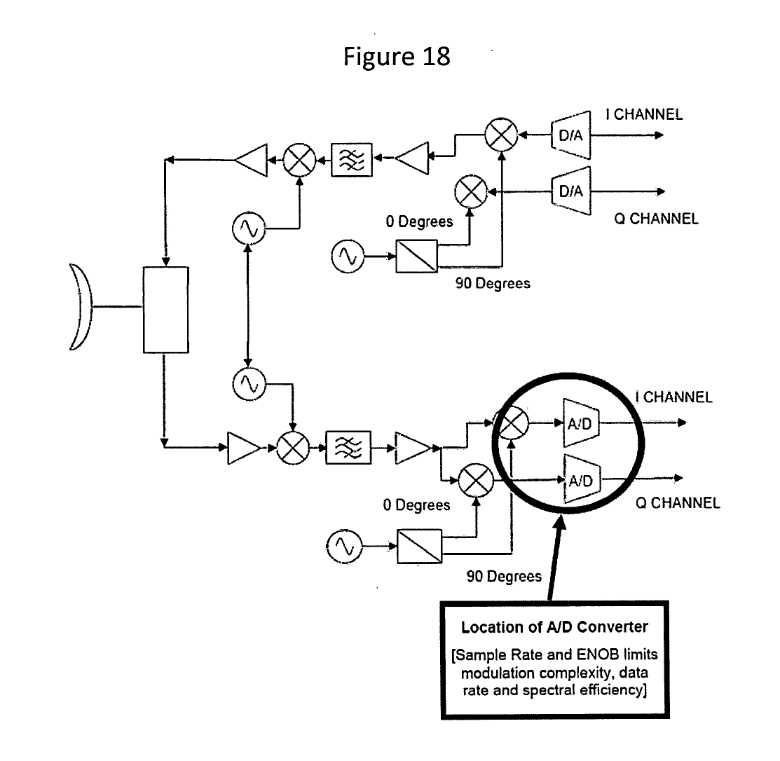

FIG. 18 is a schematic diagram of the circuitry of one embodiment of the invention.

### Section II. Successful Experimental Results

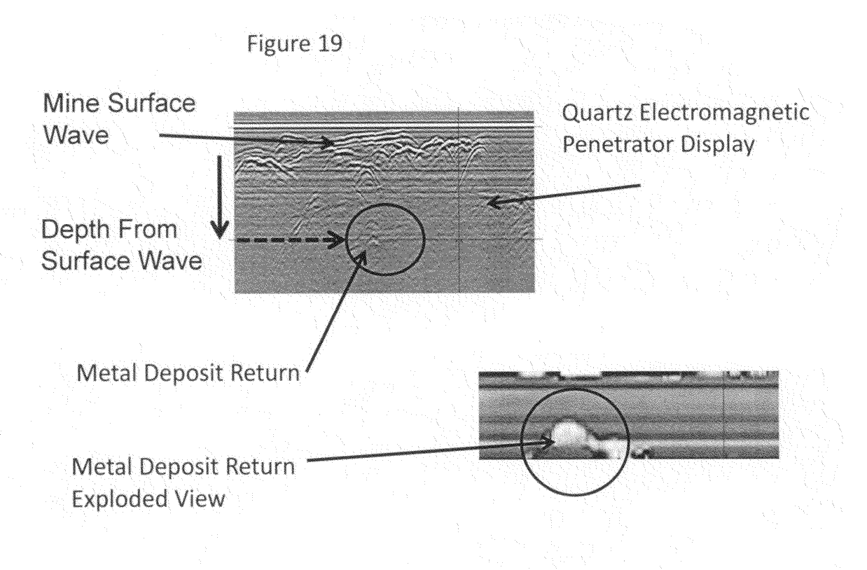

FIG. 19 depicts experimental results that show the invention has achieved new and surprising results. The present invention has succeeded where previous attempts at non-ferrous metal prospecting have failed.

In one experiment conducted in 2013, the present invention found and identified gold deposits 85 percent of the time. This compares favorably to the industry standard success rate of 5 percent.

In the experiment, holes were drilled using a AMT Air Leg Rock Drill Model No. IMT-104-W. A 3D Radar Geotech MK IV was used to propagate an Electromagnetic Plane Wave. A White Electronics MXT Pro along with a Sunray Invader DX-1 probe modified to have a 20 foot extension cable was used to propagate an H Field.

We claim:

1. An apparatus comprising:
an electromagnetic quartz penetrator; said electromagnetic quartz penetrator including a transmitter and a receiver;
said receiver including a signal processor;
said electromagnetic quartz penetrator being aimed at a two-dimensional surface of the Earth;
said electromagnetic quartz penetrator transmitter generating an Electromagnetic Plane Wave having mutually orthogonal electric and magnetic field components;
said planar wave being aimed generally orthogonally to said two-dimensional surface of the Earth, and having a spatial dissipation rate proportional to a factor of 1/r²;
said planar wave being used to identify a relatively small three-dimensional volume of Earth adjacent to said two-dimensional surface;
said three-dimensional volume of Earth being identified as containing a deposit of metal by said electromagnetic quartz penetrator;
said planar wave causing a reflection from said deposit of metal which is captured by said receiver;
said receiver including said signal processor for interpreting said reflection from said deposit of metal;
said receiver including a display for indicating the approximate spatial coordinates of said deposit of metal from said two-dimensional surface of the Earth;
an H field metal exciter and temporal sensor;
said H field metal exciter producing a magnetic field component;
said H field metal exciter being placed into a hole formed in said two-dimensional surface of the Earth which is predicted to contain a deposit of metal by said electromagnetic quartz penetrator;
said H field exciter being used to radiate an H field which induces an eddy current in a metal deposit in a vein of quartz within said small volume of Earth;
said H field exciter producing an output which has a spatial dissipation rate proportional to a factor of 1/r³;
said eddy current being characterized as a generally circular swirl of current within said metal deposit; said eddy current causing a return H Field to be radiated back to said sensor;
said temporal sensor being connected to said signal processor which is used to compute a time interval;
said temporal sensor for receiving said return H Field generated by said eddy current in said metal deposit;
said time interval being measured between a first time T1 and a second time T2;
said first time, T1, being recorded when said exciter begins to induce said eddy current in said metal deposit;
said second time, T2, being recorded when said eddy current generated field from said metal deposit that has been emanated by said eddy current is sensed by said temporal sensor and calculated by said second signal processor; and
determining that said metal deposit is non-ferrous if said time interval T2 minus T1 is generally instantaneous in duration.

2. An apparatus as recited in claim 1, in which said electromagnetic quartz penetrator is connected to a transmit antenna.

3. An apparatus as recited in claim 1, in which said electromagnetic quartz penetrator is connected to a transmit antenna array.

4. An apparatus as recited in claim 1, in which said electromagnetic quartz penetrator is connected to a receiving antenna.

5. An apparatus as recited in claim 1, in which said electromagnetic quartz penetrator is connected to a receiving antenna array.

6. An apparatus as recited in claim 1, in which said volume of Earth is located in an underground mine which is known to contain veins of quartz.

7. An apparatus as recited in claim 1, in which said relatively small three-dimensional volume of Earth adjacent to said two-dimensional surface is a few feet wide and a few feet high.

8. An apparatus as recited in claim 1, in which said hole formed in said two-dimensional surface of the Earth which is predicted to contain a deposit of metal is generally no deeper than forty feet.

9. An apparatus as recited in claim 9, in which an exciter and a sensor are both placed in the same hole.

10. An apparatus as recited in claim 1, in which said wall is drilled to contain a plurality of holes.

11. An apparatus as recited in claim 9, in which a plurality of exciters are placed in some said plurality of holes.

12. An apparatus as recited in claim 9, in which said exciter and said sensor are placed in the same hole.

13. An apparatus as recited in claim 1, in which said Electromagnetic Plane Wave and said H Field are used to locate and to identify non-ferrous metal deposits on the Moon.

14. An apparatus as recited in claim 1, in which said Electromagnetic Plane Wave and said H Field are used to locate and to identify non-ferrous metal deposits on an Asteroid.

15. An apparatus as recited in claim 1, in which said Electromagnetic Plane Wave and said H Field are used to locate and to identify non-ferrous metal deposits under a body of water.

16. An apparatus as recited in claim 1, in which said reflected energy from said Electromagnetic Plane Wave is resolved to identify a real component.

17. An apparatus as recited in claim 1, in which said reflected energy from said Electromagnetic Plane Wave is resolved to identify an imaginary component.

18. An apparatus as recited in claim 16, in which said real component is used to identify said deposit as non-ferrous and to determine its spatial location.

19. An apparatus as recited in claim 16, in which said imaginary component is used to identify said deposit as non-ferrous and to determine its spatial location.

20. A method comprising the steps of:
using an Electromagnetic Plane Wave which has a spatial power dissipation rate proportional to 1/r² to identify a deposit of metal within the Earth and the location of said deposit of metal within the Earth;
inducing an eddy current in said deposit of metal using an H Field;
said H Field having a spatial power dissipation rate proportional to 1/r³;
said eddy current creating a return signal;
receiving said return signal emanated by said eddy current; and
measuring the time required between the inducement of said eddy current in said deposit of metal and the time said return signal is received to determine whether said deposit of metal is non-ferrous.
